(19) United States
(12) Patent Application Publication
(10) Pub. No.: US 2020/0409960 A1
(43) Pub. Date: Dec. 31, 2020

(54) TECHNIQUE FOR LEVERAGING WEAK LABELS FOR JOB RECOMMENDATIONS

(71) Applicant: Microsoft Technology Licensing, LLC, Redmond, WA (US)

(72) Inventors: Varun Mithal, Sunnyvale, CA (US); Girish Kathalagiri Somashekariah, Santa Clara, CA (US)

(21) Appl. No.: 16/454,610

(22) Filed: Jun. 27, 2019

(51) Int. Cl. G06F 16/2457; G06N 20/00; G06N 3/08; G06F 16/9035

(52) U.S. Cl. CPC G06F 16/24578; G06F 16/9035; G06N 3/08; G06N 20/00

(57) ABSTRACT

Described herein are methods and systems for using weak labels to train a model for use in identifying job listings that are relevant to a user of an online job hosting service. The weak labels correspond with various user actions that a user has undertaken with respect to job listings presented to the user. By way of example, the relevant user actions may include: Job Applies, Job Saves, Job Views, Job Skips and Job Dismisses.

### TECHNICAL FIELD

The present application generally relates to supervised machine learning techniques for learning models for use in making job listing recommendations to users of an online job hosting service. More specifically, the application describes techniques for training models using training data having weak labels derived from user actions.

### BACKGROUND

Many online job hosting services have job recommendation services that attempt to identify and recommend job listings that best match the experiences and interests of users. When requested, or perhaps on some periodic basis, a job recommendation service will present some top number of “best” (e.g., highest ranked, or, closest matching) job listings to the user. Some job recommendation services use supervised machine learning techniques to learn one or more models for classifying and/or ranking job listings for each user. Some of these learned models operate on a per-user basis (e.g., personalized models), such that the ranking of job listings is dependent upon the individual actions taken by each user with respect to the specific job listings presented to the user. However, training such models can be difficult when there is insufficient training data. In such instances, alternative and non-conventional approaches are needed.

### BRIEF DESCRIPTION OF THE DRAWINGS

Embodiments of the present invention are illustrated by way of example and not limitation in the figures of the accompanying drawings, in which:

FIG. 1 is a block diagram illustrating one supervised machine learning approach to using user actions in labeling data for learning a model to classify job listings;

FIG. 2 is a block diagram illustrating an improved supervised machine learning approach to using user actions in labeling data for learning a model to classify job listings, consistent with embodiments of the present invention;

FIG. 3 is a functional block diagram illustrating functional components of an online job hosting service having a recommendation engine, for recommending job listings to users, consistent with embodiments of the present invention;

FIG. 4 is a user interface diagram illustrating example user interfaces via which user actions are detected, such that the user actions can be used in labelling training data for use in training a model to classify job listings for recommendation to users of an online job hosting service, consistent with embodiments of the present invention;

FIG. 5 is a flow diagram illustrating an example of method operations for training a model with weak labels, derived from user actions, and for use in classifying job listings for recommending to users, consistent with embodiments of the present invention;

FIG. 6 is a flow diagram representing an example of method operations for generating recommendations of job listings, consistent with embodiments of the present invention; and

FIG. 7 illustrates a diagrammatic representation of a machine in the form of a computer system within which a set of instructions may be executed for causing the machine to perform any one or more of the methodologies discussed herein, consistent with embodiments of the present invention.

### DETAILED DESCRIPTION

Described herein are methods and systems, using supervised machining learning techniques, for training models for use in classifying job listing recommendations for use with a recommendation engine, where each model is used to classify job listings as relevant or irrelevant for recommending to an individual user of an online job hosting service, and the training data used to train the model(s) include multiple categories of labeled data based on user actions. In the following description, for purposes of explanation, numerous specific details and features are set forth in order to provide a thorough understanding of the various aspects of different embodiments of the present invention. It will be evident, however, to one skilled in the art, that the present invention may be practiced with varying combinations of the many details and features.

### Overview

Many online job hosting services have job recommendation and search services that attempt to identify job listings that best match the experiences and interests of users. When requested, or perhaps on some periodic basis, a job recommendation service will present some top number of “best” (e.g., highest ranked) job listings to the user. Some job recommendation services use supervised machine learning techniques to learn a model for classifying (e.g., as relevant or irrelevant) the job listings for each user. Some of these learned models operate on a per-user basis (e.g., personalized models), such that the ranking of job listings is dependent upon the individual actions taken by each user with respect to the specific jobs presented to the user. However, training such models can be difficult if there is not sufficient training data.

In order to learn how to rank jobs for users, training data in the form of examples of relevant and irrelevant job listing recommendations are required to train the models. Typically, being able to learn a good model depends on whether there is a sufficient volume of training data (e.g., job listing recommendations labeled as relevant, or irrelevant). However, getting a sufficient volume of training data for recommendations of job listings is challenging. Generally, two types of labeled training samples exist. The first type of training example can be thought of as an explicit label/signal that arises from explicit user actions, such as when a user applies for a recommended job (Job Apply), takes action to save a recommended job for later viewing (Job Save), or takes action to dismiss a recommended job (Job Dismiss). The second type of labeled training example can be thought of as an implicit label/signal, which, for example, arise from user actions for which a more subtle inference can be drawn. For example, implicit labels/signals arise when a user is presented with a job listing recommendation and chooses to view the job listing (referred to herein as a Job View), or alternatively, chooses not to view the job recommendation (referred to herein as a Job Skip). While explicit labels/signals are of higher quality, they tend to be far fewer in quantity. Thus, in accordance with embodiments of the present invention, using implicit labels/signals addresses the challenges posed by there being insufficient training samples, especially when training personalized per-member random effect components of a recommendation engine. A single member is unlikely to have an adequate number of explicit labels/signals for training a robust per-member model for that member.

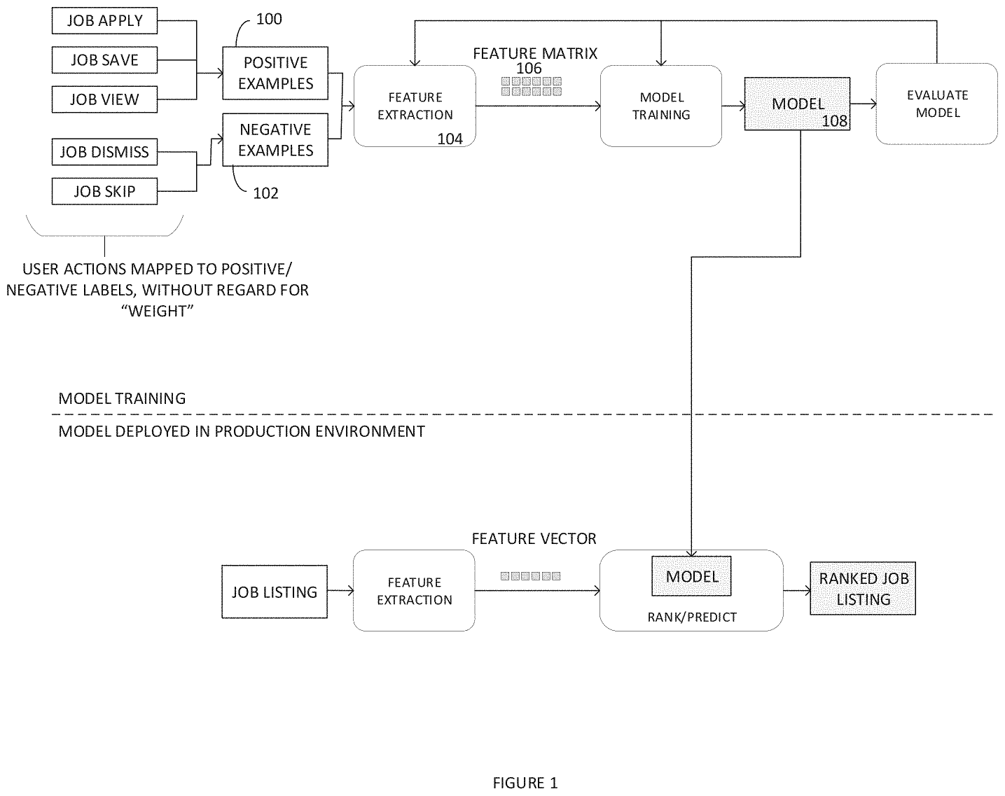

As illustrated in FIG. 1, one approach to using user actions in labelling training data is to simply map the user actions to one of two target classes (e.g., positive or relevant job listings, or, negative or irrelevant job listings). For example, as illustrated in FIG. 1, the explicit user actions, “Job Apply” and “Job Save” are mapped to a first target class (e.g., “Positive Examples” 100) along with the implicit user action, “Job View”, whereas the explicit user action, “Job Dismiss” and the implicit user action, “Job Skip” are mapped to a second target class (e.g., “Negative Examples” 102). Accordingly, the job listings that correspond with the two labels (e.g., positive, and negative) are then provided as input to a feature extraction engine 104, which generates a feature matrix 106 from the various features of the job listings. Using the feature matrix, a model 108 is trained and evaluated. Finally, in a production environment 110, the trained model 112 is used to classify/rank new job listings 114 for recommendation to the user.

The problem with this approach is that the learned model does not take into consideration the relevant weight or importance of the different signals (e.g., user actions) that are mapped to the two target classes. For instance, it is inherently easy to understand that, when a user simply views a job listing, this user action is not as strong of a signal of interest in a job listing as when the user saves the job listing, or actually applies for the position associated with the job listing. Similarly, when a user interacts with a user interface element (e.g., a button) to dismiss a job listing, this explicit user action expresses more disinterest in the job listing than when a user is presented with a job listing in a list of recommended job listings, but simply skips over (e.g., does not select for viewing) the job listing. Accordingly, the result is that the learned ranking model is not as effective as it could be and users are ultimately likely to be presented with job listing recommendations that are less relevant, and/or, certain relevant job listing recommendations that could and should be presented to a user will not be.

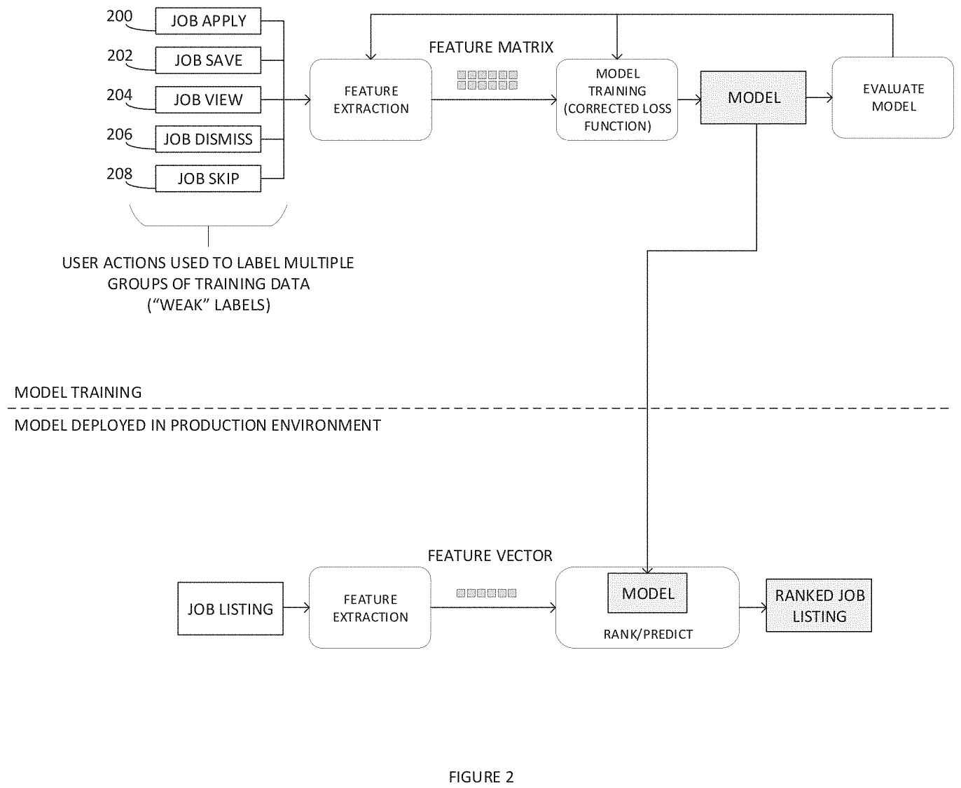

Consistent with embodiments of the present invention and as illustrated in FIG. 2, an improved approach is to use multiple groups of training data with each group consisting of training data (e.g., job listings) selected based on a user action undertaken by the user. For example, as illustrated in FIG. 2, the training data consists of multiple groups, with each group representing a different user action—for example, Job Apply 200, Job Save 202, Job View 204, Job Dismiss 206, and Job Skip 208. In this way, certain explicit signals (e.g., Job Apply and Job Dismiss), for which there may be very few observations, can be supplemented with “weaker” implicit signals (e.g., Job View and Job Skip), for which observations may be abundant. Under this approach, each instance of a job listing for which a user has undertaken a relevant action is a training example corresponding to a mixture of positive label (e.g., relevant job listing) and negative label (irrelevant job listing). The mixing proportion corresponding to each weak label is different, and in a real-world scenario, unknown. To handle the imperfection in the labels a corrected loss function or objective function is used, such that optimizing with the corrected loss function using the weak labels will ensure that the original loss (e.g., logistic loss) on the true (e.g., unobserved) labels will be optimized. Accordingly, the weight (e.g., measure of importance) of each weak label (e.g., each user action) is treated as a hyper-parameter in the objective or loss function, and the most suitable values for the weights are determined by optimizing on performance using a validation data set. Other advantages and aspects of the present invention will be readily apparent from the description of the figures that follow

### Details of Various Embodiments

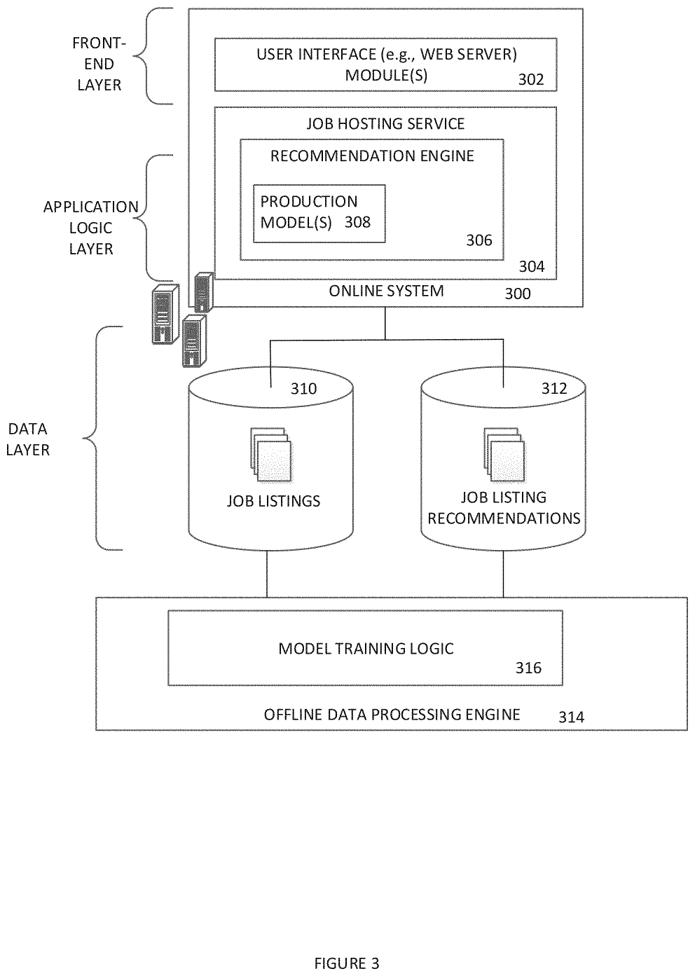

FIG. 3 is functional block diagram illustrating the various functional components that might be included in a computing environment in which embodiments of the invention are implemented and deployed. As shown in FIG. 3, the online system 300 is implemented with a three-layered architecture, generally consisting of a front-end layer, an application logic layer and a data layer. Of course, in other embodiments, different architectures may be used.

The front-end layer may comprise a user interface module (e.g., a web server) 302, which receives requests from various client computing devices and communicates appropriate responses to the requesting client devices. For example, the user interface module(s) 302 may receive requests in the form of Hypertext Transfer Protocol (HTTP) requests or other web-based API requests.

The application logic layer may include one or more various application server modules or services (e.g., job hosting service 304), which, in conjunction with the user interface module(s) 302, generate various user interfaces (e.g., web pages) with data retrieved from various data sources in the data layer. Consistent with some embodiments, individual application server modules (not shown) are used to implement the functionality associated with various applications and/or services provided by the online system 300, beyond the functions of the job hosting service 304. For example, with some embodiments, the job hosting service 304 may be integrated with a social networking system or service offering a variety of other functions and services, such as a news feed, photo sharing, and so forth.

As illustrated in FIG. 3, the job hosting service 304 includes a recommendation engine 306 that uses one or more machine-learned models, including one or more models that have been trained using supervised learning techniques with multiple groups of training examples that are grouped based on different user actions that a user has taken with respect to different job listings. By way of example, the user actions might include: Job Apply—when a user views a job listing and then applies for the position described in the job listing; Job Save—when a user takes some explicit action (e.g., interacts with a user interface element, such as a button) to save a job listing for subsequent viewing; Job View—when a user takes some action to select a job listing for viewing, for example, such as when a user selects a job listing from a list of job listings in order to see a detailed view of the job listing; Job Skip—when a user is presented with a job listing, for example, such as the case may be when a list of job listings are presented, and the user does not select the job listing; and, Job Dismiss—when the user takes some explicit user action (e.g., interacts with a user interface element, such as a button) to formally dismiss a job listing.

As shown in FIG. 3, the data layer may include several databases, such as a job listings database 310 for storing job listings, and a job listing recommendations database 312. Consistent with some embodiments, when a person initially registers to become a member of the job hosting service, the person will be prompted to provide some information, such as his or her name, age (e.g., birthdate), gender, interests, contact information, home town, address, spouse's and/or family members' names, educational background (e.g., schools, majors, matriculation and/or graduation dates, etc.), employment history, skills, professional organizations, and so on. This information may be stored, for example, in a member profile database (not shown) and then used as input, along with data from the job listings database 310, to one or more recommendation algorithms, including the ranking and classification algorithms described herein and consistent with embodiments of the present invention. Additionally, a job search engine may provide users with a search function for searching the job listings stored in the job listings database 310. In any case, the member profile data, the job listings, and any user actions detected, including those actions taken with respect to any recommended job listings, or job listings displayed in search results, will be used as input data to the one or more recommendation algorithms that use machine-learned models for ranking and/or classifying job listings, for recommendation to users of the online job hosting service.

As shown in FIG. 3, the offline data processing engine 314 comprises one or more frameworks for distributed storage and processing of extremely large data sets, and machine learning. In one example, the offline data processing engine may be implemented using any one of a number of machine learning frameworks. Using resources of the machine learning framework, the model training logic 316 is programmatically configured to obtain data from relevant sources in the data layer, for the purpose of training one or more models for use by the recommendation engine 306. For instance, the model training logic 316 may obtain data from the job listings database 108, and data from one or more other databases (not shown) for the purpose of generating models for use in classifying job listings as relevant, or irrelevant, to users of the online job hosting service 304.

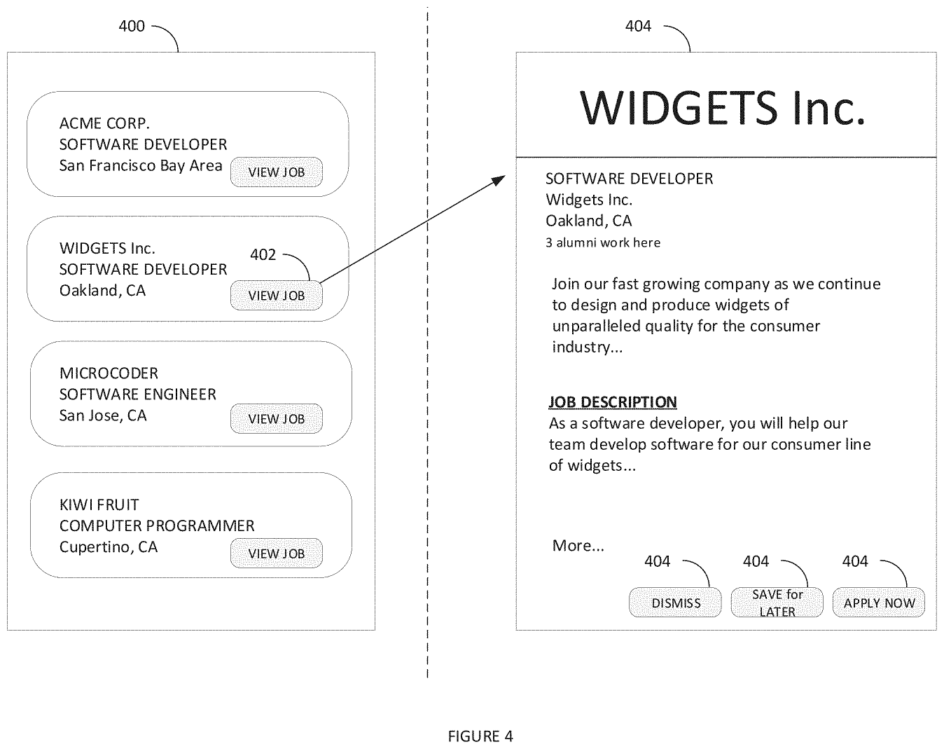

FIG. 4 is a user interface diagram illustrating example user interfaces via which user actions are detected, such that the user actions can be used in labelling training data for use in training a model to classify job listings for recommendation to users of an online job hosting service, consistent with embodiments of the present invention. As illustrated in FIG. 4, a first example user interface 400 shows a listing of ranked job listings. This listing may, for example, by generated as part of a job recommendation engine, or alternatively, in response to a search query initiated by the user. In any case, the job listings in the list of the example user interface 400 each include a user interface control element (e.g., in the form of a button 402), which, when selected by the user, will result in the presentation of a detailed view of the selected job listing. Accordingly, consistent with some embodiments of the invention, a Job View user action occurs when the user selects a job listing for the purpose of viewing the detailed view of the job listing. Similarly, when a job listing is presented in such a list, as shown in FIG. 4, when the user does not elect to view the detailed view of the job listing, this results in a user action referred to herein as a Job Skip. These user actions, Job Views and Job Skips, are considered implicit signals, and are therefore considered the weakest of the weak labeled training examples. Nonetheless, their relative weights are not inferred, but instead, are computed in a principled manner as described in greater detail below.

In FIG. 4, the second example user interface 404 is a detailed view of the job listing selected by the user from the listing of job listings shown in user interface 400. In this example, the detailed view of the job listing 404 includes several user interface control elements (e.g., buttons) that correspond with user actions that are used in labeling training examples. For instance, the button with label “Dismiss” corresponds with the user action, Job Dismiss. Accordingly, when a user is presented with a detailed view of a job listing, and ultimately elects to dismiss the job listing, this action is detected and used in labeling the corresponding job listing as a training example, with the label, Job Dismiss. Similarly, the detailed view of the job listing includes additional buttons labeled, “Save for Later”—corresponding with the user action, Job Save—and a third button labeled, “Apply Now”—corresponding with the user action, Job Apply. When users interact with these buttons, the corresponding events are detected and stored for subsequent use in training a model. For example, some job listing identifier may be stored in association with some data representing the action that the member has taken, along with the identifier of the member, and perhaps the day/time the event occurred.

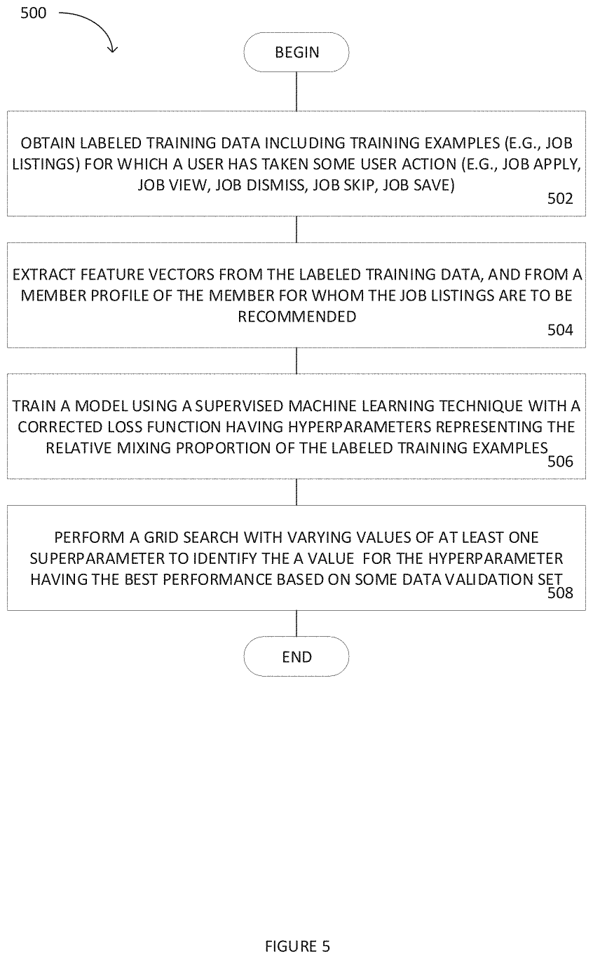

FIG. 5 is a flow diagram illustrating an example of method operations for training a model with weak labels, derived from user actions, and for use in classifying job listings for recommending to users, consistent with embodiments of the present invention. With some embodiments, the job listing recommendations are generated using a combination of a global model, (e.g., derived with training examples from the entire population of users) and a personalized model (e.g., derived with training examples specific to the individual user). As training data will generally be abundant for the global model, the present invention is primarily applicable in the context of training each personalized model for each individual user. Of course, even when using the methods described herein, if a user does not actively engage with job listings, there may simply be insufficient training examples to train a personalized model. Accordingly, with some embodiments, before training a model, a determination is made as to whether, for a given user, there exists a sufficient volume of training data. If not, the global model is used exclusively to generate the job listing recommendations. However, if there is sufficient training data for an individual user, the results of the personalized model are used to enhance the results of the global model.

At method operation 502, labeled training data is obtained for the particular user on whose behalf the job listing recommendations are to be generated. For instance, as described in connection with the example user interfaces of FIG. 4, when a user takes certain actions with respect to job listings presented to the user, these actions are detected and recorded for use in generating training examples for the user. Next, at operation 504, the training examples are subjected to a feature extraction process where the individual features of the training examples are generated. At method operation 506, the feature matrix is provided as input to the model training logic, which, using a supervised machine learning technique and a corrected loss function or objective function, processes the feature matrix to generate a machine learned model. As the model includes several hyper-parameters, at method operation 508, a grid search is performed over varying values of at least one hyper-parameter to identify the value that gives the best performance using some data validation set. Once the final model is determined, on some periodic basis the model is used to generate a ranked list of job listings for the user. Accordingly, as the personalized model is a classification model, with some embodiments, only those job listings that are classified as relevant by the personalized model are subjected to further processing for the purpose of ranking.

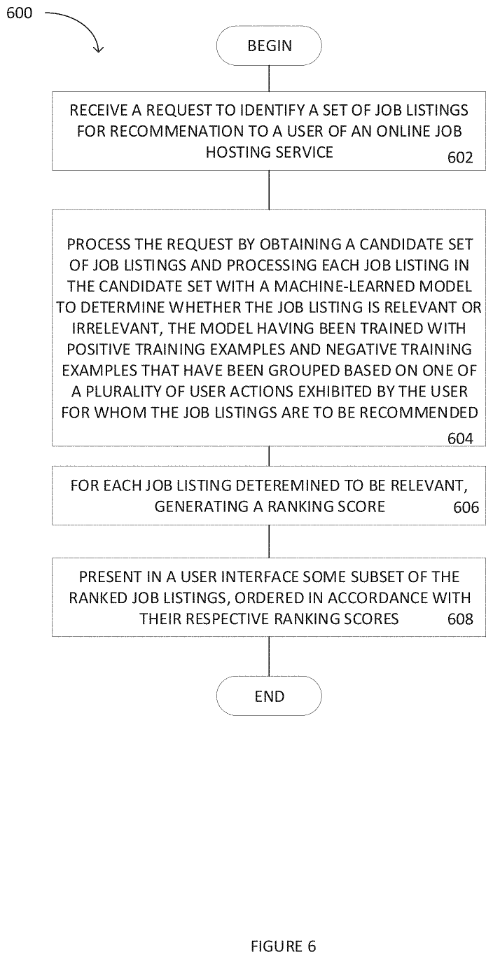

FIG. 6 is a flow diagram representing an example of method operations for generating recommendations of job listings, consistent with embodiments of the present invention. At method operation 602, a request is received to identify a set of job listings for recommendation to a user of the online job hosting service. For instance, with some embodiments, on some periodic basis, for some subset of users, job recommendations are generated for presentation to the users. With some embodiments, the job listing recommendations are pre-computed, such that, during an active session of the user, the job recommendations can simply be recalled from storage. Of course, in other embodiments, the job recommendations may be generated in real-time, for example, in response to a user-initiated request. Accordingly, a request to identify the job listing recommendations for a user may be system-generated, on some periodic schedule, or may be based on a user-initiated request.

In any case, at method operation 604, the request is processed by first obtaining for the user some candidate set of job listings, and then for each job listing in the candidate set, processing the job listing with a machine-learned classification model that has been trained with training examples—both positive and negative training examples—that are grouped into multiple groups based on some user actions. Accordingly, each user action represents a weak label for the respective training example to which it applies.

Next, at operation 606, for each job listing recommendation that, according to the model, is classified as relevant to the user for whom the job listing recommendations are to be generated and ultimately presented, a ranking score is generated. For example, a global machine-learned model might be used to derive ranking scores for the respective job listings. Finally, at method operation 608, a user interface is presented to the user, where the user interface presents some subset of the ranked job listing recommendations, ordered in accordance with their respective rankings scores.

### An Example

The following is a description of one example of an embodiment of the present invention, expressed mathematically. Specifically, in this example, the mathematical formulas are provided for training examples that are grouped by the following three user actions: Job Applies, Job Dismisses and Job Skips.

Training a classification model using a supervised machine learning technique involves learning a function g(x) such as to minimize a loss l(y,g(x)). More formally, the optimization involves optimizing for risk (e.g., the expected value of loss over the data distribution) defined as:

R(g)=E_{(x,y)˜p(x,y)}[l(y*g(x)]

which can be re-written as,

R(g)=πE_{(x)˜Ppositive(x)[l(g(x)+(}1−π)E_{(x)˜Pnegative(x)[}l(−g(x)]

with,

π being the class prior (i.e., the fraction of positives in the entire data set),

Ppositive(x) being the data distribution of positive class,

Pnegative(x) being the data distribution of negative class.

By way of example, logistic regression corresponds to learning the sigmoid function on a linear combination of input x to minimize logistic loss ln(1+exp(−y*g(x))). Using the above formulation for R(g) assumes that the training data has sufficient and representative positive and negative examples drawn from Ppositive(x) and Pnegative(x) respectively. When sufficient training examples are not available, an alternative approach is needed. Consistent with embodiments of the invention, the alternative approach uses training examples associated with weak labels—that is, job listings associated with user actions where the user action is used to infer the negative or positive label.

Assuming there are two groups of training examples with weak labels, B1 and B2, then X_{B1} are samples drawn from B1, and X_{B2} are samples drawn from B2. The assumption on generative process for data in B1 and B2 is given as,

P_{B1}(x)=θ_{B1}Ppositive(x)+(1−θ_{B1})P_{negative}(x)

P_{B2}(x)=θ_{B2}Ppositive(x)+(1−θ_{B2})P_{negative}(x)

The above formulation expresses that the weak label samples can be considered as drawn from positive and negative population with the mixing coefficients, θ_{B1} and θ_{B2}, respectively.

This leads to a corrected training objective. In the case of weak labels, samples are drawn from P_{B1}(x) and P_{B2}(x), instead of Ppositive (x) and Pnegative(x). The objective function, R(g) is then re-writable in terms of samples drawn from P_{B1}(x) and P_{B2}(x) as,

R(g)=aE_{x˜pB1}(x)[l(g(x)]+bE_{x˜pB1}(x)[l(−g(x)]+cE_{x˜pB2}(x)[l(g(x)]+dE_{x˜pB2}(x)[l(−g(x)]

This is possible for hyper-parameters (a, b, c, d) that satisfy the following,

aθ_{B1}+Cθ_{B2}=π,

a(1−θ_{B1})+c(1−θ_{B2})=0,

bθ_{B1}+dθ_{B2}=0,

b(1−θ_{B1})+d(1−θ_{B2})=1−π

If θ_{B1} and θ_{B2} are known, then solving for the hyper-parameters (a, b, c, d) involves a set of four linear equations in four variables, and can be solved as,

a=π(1−θ_{B2})θ_{B1}−θ_{B2}a=π(1−θ_{B2})θB1−θB2

b=−(1−π)θ_{B2}θ_{B1}−θ_{B2}b=−(1−π)θB2θB1−θB2

c=−π(1−θ_{B1})θ_{B1}−θ_{B2}c=−π(1−θ_{B1})θB1−θB2

d=(1-π)θ_{B1}θ_{B1}−θ_{B2}

Using these values for the hyper-parameters (a, b, c, d), a classification model g(x) can be learned and which optimizes R(g) using weakly labeled samples X_{B1} and X_{B2}.

Consistent with embodiments of the invention, the concept expressed above can be extended to situations when more than two labels are available. Take as an example a job listing recommendation engine that considers user actions relating to Job Applies, Job Dimisses, and Job Skips—two strong labels, and one weak label—in labeling training data. The objective function from above can now be rewritten as,

$$R ( g ) = {aE}_{( x ) ∼ {p}_{B 1} ( x )} [ l ( g ( x ) ] + {bE}_{( x ) ∼ {p}_{B 1} ( x )} [ l ( - g ( x ) ] + {cE}_{( x ) ∼ {p}_{B 2} ( x )} [ l ( g ( x ) ] + {dE}_{( x ) ∼ {p}_{B 2} ( x )} [ l ( - g ( x ) ] + {eE}_{( x ) ∼ {p}_{B 3} ( x )} [ l ( g ( x ) ] + {fE}_{( x ) ∼ {p}_{B 3} ( x )} [ l ( - g ( x ) ]$$

This is possible for hyperparameters (a, b, c, d, e, f) setting that satisfies,

aθ_{B1}+cθ_{B2}+eθ_{B3}=π

a(1−θ_{B1})+c(1−θ_{B2})+e(1−θ_{B3})=0

bθ_{B1}+dθ_{B2}+fθ_{B3}=0

b(1−θ_{B1})+d(1−θ_{B2})+f(1−θ_{B3})=1−π

Here, B1 is Job Applies, B2 is Job Dimisses, and B3 is Job Skips. Since the user action, Job Apply, is considered a strong positive signal, 8B1=1. Similarly, since Job Dismiss is a strong negative, θ_{B2}=0. This gives,

a+eθ_{B3}=π

c+e(1−θ_{B3})=0

b+fθ_{B3}=0

d+f(1−θ_{B3})=1−π

This has an infinite number of solutions. One solution is as follows,

a=π

b=−fθ_{B3}

c=0

d=1−π−f(1−θ_{B3})

e=0

f=?

Note, since θ_{B3} is expected to be very small, it can be approximated to 0. This makes the estimate for b to be 0, and for d to be (1−π−f). The new objective function can then be re-written as,

R(g)=πE_{(x)˜pB1(x)}[l(g(x)]+(1−π−f)E_{(x)˜pB2(x)}[l(−g(x)]+fE_{(x)˜pB3(x)}[l(−g(x)]

This is equivalent to using Job Applies with a weight of π, Job Dismisses with a weight of (1−π−f), and Job Skips with a weight of f.

Finally, a grid search over different values of f can be performed to identify the value of f that produces the best performance on some validation set.

### Example Computer System

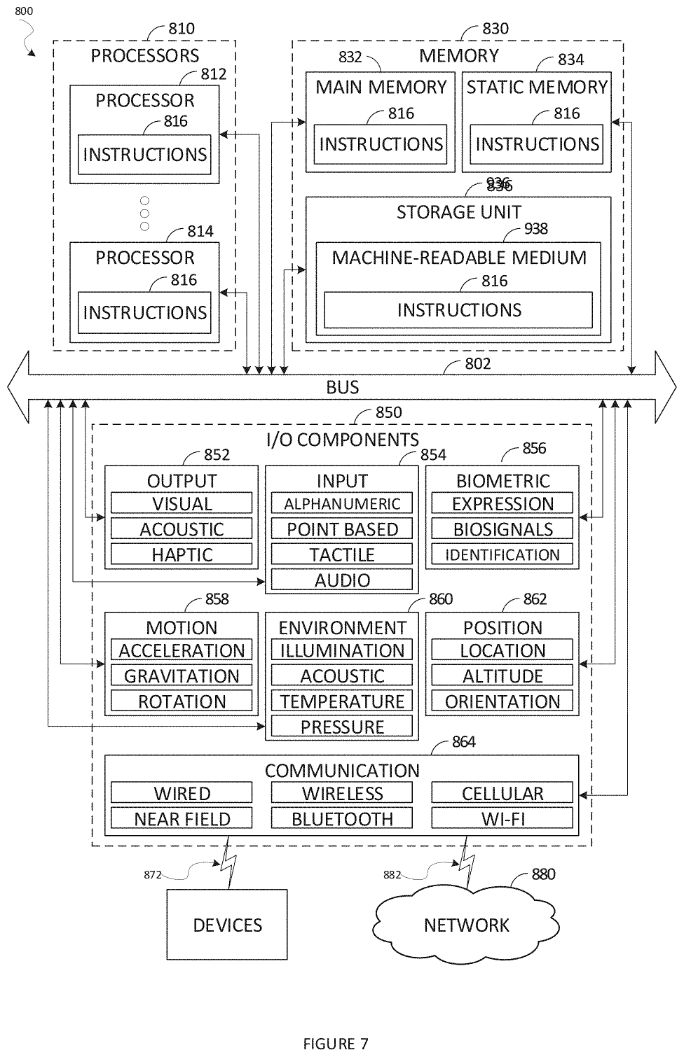

FIG. 7 illustrates a diagrammatic representation of a machine 800 in the form of a computer system within which a set of instructions may be executed for causing the machine to perform any one or more of the methodologies discussed herein, according to an example embodiment. Specifically, FIG. 7 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein may be executed. For example the instructions 816 may cause the machine 800 to execute method 500, or similar methods. Additionally, or alternatively, the instructions 816 may implement the systems described in connection with FIG. 1, and so forth. The instructions 816 transform the general, non-programmed machine 800 into a particular machine 800 programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a PC, a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines 800 that individually or jointly execute the instructions 816 to perform any one or more of the methodologies discussed herein.

The machine 800 may include processors 810, memory 830, and I/O components 850, which may be configured to communicate with each other such as via a bus 802. In an example embodiment, the processors 810 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 812 and a processor 814 that may execute the instructions 816. The term “processor” is intended to include multi-core processors that may comprise two or more independent processors (sometimes referred to as “cores”) that may execute instructions contemporaneously. Although FIG. 5 shows multiple processors 810, the machine 800 may include a single processor with a single core, a single processor with multiple cores (e.g., a multi-core processor), multiple processors with a single core, multiple processors with multiples cores, or any combination thereof.

The memory 830 may include a main memory 832, a static memory 834, and a storage unit 836, all accessible to the processors 810 such as via the bus 802. The main memory 830, the static memory 834, and storage unit 836 store the instructions 816 embodying any one or more of the methodologies or functions described herein. The instructions 816 may also reside, completely or partially, within the main memory 832, within the static memory 834, within the storage unit 836, within at least one of the processors 810 (e.g., within the processor's cache memory), or any suitable combination thereof, during execution thereof by the machine 800.

The I/O components 850 may include a wide variety of components to receive input, provide output, produce output, transmit information, exchange information, capture measurements, and so on. The specific I/O components 850 that are included in a particular machine will depend on the type of machine. For example, portable machines such as mobile phones will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion and the grouping is in no way limiting. In various example embodiments, the I/O components 850 may include output components 852 and input components 854. The output components 852 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 854 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 850 may include biometric components 856, motion components 858, environmental components 860, or position components 862, among a wide array of other components. For example, the biometric components 856 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 862 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 850 may include communication components 864 operable to couple the machine 800 to a network 880 or devices 870 via a coupling 882 and a coupling 872, respectively. For example, the communication components 864 may include a network interface component or another suitable device to interface with the network 880. In further examples, the communication components 864 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 870 may be another machine or any of a wide variety of peripheral devices (e.g., a peripheral device coupled via a USB).

Moreover, the communication components 864 may detect identifiers or include components operable to detect identifiers. For example, the communication components 864 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 864, such as location via Internet Protocol (IP) geolocation, location via Wi-Fi® signal triangulation, location via detecting an NFC beacon signal that may indicate a particular location, and so forth.

The various memories (i.e., 830, 832, 834, and/or memory of the processor(s) 810) and/or storage unit 836 may store one or more sets of instructions and data structures (e.g., software) embodying or utilized by any one or more of the methodologies or functions described herein. These instructions (e.g., the instructions 816), when executed by processor(s) 810, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 880 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 880 or a portion of the network 880 may include a wireless or cellular network, and the coupling 882 may be a Code Division Multiple Access (CDMA) connection, a Global System for Mobile communications (GSM) connection, or another type of cellular or wireless coupling. In this example, the coupling 882 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 816 may be transmitted or received over the network 980 using a transmission medium via a network interface device (e.g., a network interface component included in the communication components 864) and utilizing any one of a number of well-known transfer protocols (e.g., HTTP). Similarly, the instructions 816 may be transmitted or received using a transmission medium via the coupling 872 (e.g., a peer-to-peer coupling) to other devices. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 816 for execution by the machine 800, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A computer-implemented method comprising:
receiving a request to identify a set of job listings for recommendation to a user;
processing the request to generate a ranked list of job listings for recommendation to the user, the request processed in part by obtaining a candidate set of job listings for recommendation to the user, processing each job listing in the candidate set of job listings with a machine learned model to classify each job listing in the set of candidate job listings as relevant or irrelevant with respect to the user, the machine learned model having been trained with positive training examples and negative training examples that have been grouped based on one of a plurality of user actions exhibited by the user for whom the job listings are to be recommended;
ranking each job listing in the candidate set of job listings that the machine learned model classifies as relevant for the user; and
presenting in a user interface some subset of the ranked job listings in order of their respective rank.

2. The computer-implemented method of claim 1, wherein the positive training examples and the negative training examples have been grouped into three groups by user actions, the three groups including a first group representing training examples for which the user action involves a user having applied for a job that is associated with a job listing presented to the user, a second group representing training examples for which the user has viewed a job listing, and a third group representing training examples for which the user has skipped over a job listing.

3. The computer-implemented method of claim 1, wherein the positive training examples and the negative training examples have been grouped into three groups by user actions, the three groups including a first group representing training examples for which the user action involves a user having applied for a job that is associated with a job listing presented to the user, a second group representing training examples for which the user has dismissed a job listing, and a third group representing training examples for which the user has skipped over a job listing.

4. The computer-implemented method of claim 1, wherein relative weights of the user actions for both positive training examples and negative training examples are expressed in a loss function as hyper-parameters, and solving for at least one of the hyper-parameters involves performing a grid search over varying values of the at least one hyper-parameter to find values of the one hyper-parameter that exhibit an optimal performance using a validation data set.

5. The computer-implemented method of claim 1, wherein ranking each job listing in the candidate set of job listings that the machine learned model classifies as relevant for the user comprises:
using a second machine learned model to rank the relevant job listings, the second machine learned model having been globally trained with training data relating to user actions of a plurality of users.

6. The computer-implemented method of claim 1, further comprising:
prior to processing each job listing in the candidate set of job listings with a machine learned model to classify each job listing in the set of candidate job listings as relevant or irrelevant with respect to the user, determining that a machine-learned model has been trained for the user, wherein no machine learned model is trained for a user if there is an insufficient number of training examples for the user.

7. A system comprising:
a memory storage device storing executable instructions; and
a processor, which, when executing the instructions, causes the system to:
receive a request to identify a set of job listings for recommendation to a user;
process the request to generate a ranked list of job listings for recommendation to the user, the request processed in part by obtaining a candidate set of job listings for recommendation to the user, processing each job listing in the candidate set of job listings with a machine learned model to classify each job listing in the set of candidate job listings as relevant or irrelevant with respect to the user, the machine learned model having been trained with positive training examples and negative training examples that have been grouped based on one of a plurality of user actions exhibited by the user for whom the job listings are to be recommended;
rank each job listing in the candidate set of job listings that the machine learned model classifies as relevant for the user; and
present in a user interface some subset of the ranked job listings in order of their respective rank.

8. The system of claim 7, wherein the positive training examples and the negative training examples have been grouped into three groups by user actions, the three groups including a first group representing training examples for which the user action involves a user having applied for a job that is associated with a job listing presented to the user, a second group representing training examples for which the user has viewed a job listing, and a third group representing training examples for which the user has skipped over a job listing.

9. The system of claim 7, wherein the positive training examples and the negative training examples have been grouped into three groups by user actions, the three groups including a first group representing training examples for which the user action involves a user having applied for a job that is associated with a job listing presented to the user, a second group representing training examples for which the user has dismissed a job listing, and a third group representing training examples for which the user has skipped over a job listing.

10. The system of claim 7, wherein relative weights of the user actions for both positive training examples and negative training examples are expressed in a loss function as hyper-parameters, and solving for at least one of the hyper-parameters involves performing a grid search over varying values of the at least one hyper-parameter to find values of the one hyper-parameter that exhibit an optimal performance using a validation data set.

11. The system of claim 7, wherein ranking each job listing in the candidate set of job listings that the machine learned model classifies as relevant for the user comprises:
using a second machine learned model to rank the relevant job listings, the second machine learned model having been globally trained with training data relating to user actions of a plurality of users.

12. The system of claim 7, further comprising:
prior to processing each job listing in the candidate set of job listings with a machine learned model to classify each job listing in the set of candidate job listings as relevant or irrelevant with respect to the user, determining that a machine-learned model has been trained for the user, wherein no machine learned model is trained for a user if there is an insufficient number of training examples for the user.

13. A computer-readable storage medium storing instructions, which, when executed by a processor, cause the processor to:
receive a request to identify a set of job listings for recommendation to a user;
process the request to generate a ranked list of job listings for recommendation to the user, the request processed in part by obtaining a candidate set of job listings for recommendation to the user, processing each job listing in the candidate set of job listings with a machine learned model to classify each job listing in the set of candidate job listings as relevant or irrelevant with respect to the user, the machine learned model having been trained with positive training examples and negative training examples that have been grouped based on one of a plurality of user actions exhibited by the user for whom the job listings are to be recommended;
rank each job listing in the candidate set of job listings that the machine learned model classifies as relevant for the user; and
present in a user interface some subset of the ranked job listings in order of their respective rank.

14. The system of claim 13, wherein the positive training examples and the negative training examples have been grouped into three groups by user actions, the three groups including a first group representing training examples for which the user action involves a user having applied for a job that is associated with a job listing presented to the user, a second group representing training examples for which the user has viewed a job listing, and a third group representing training examples for which the user has skipped over a job listing.

15. The system of claim 13, wherein the positive training examples and the negative training examples have been grouped into three groups by user actions, the three groups including a first group representing training examples for which the user action involves a user having applied for a job that is associated with a job listing presented to the user, a second group representing training examples for which the user has dismissed a job listing, and a third group representing training examples for which the user has skipped over a job listing.

16. The system of claim 13, wherein relative weights of the user actions for both positive training examples and negative training examples are expressed in a loss function as hyper-parameters, and solving for at least one of the hyper-parameters involves performing a grid search over varying values of the at least one hyper-parameter to find values of the one hyper-parameter that exhibit an optimal performance using a validation data set.

17. The system of claim 13, wherein ranking each job listing in the candidate set of job listings that the machine learned model classifies as relevant for the user comprises:
using a second machine learned model to rank the relevant job listings, the second machine learned model having been globally trained with training data relating to user actions of a plurality of users.

18. The system of claim 13, further comprising:
prior to processing each job listing in the candidate set of job listings with a machine learned model to classify each job listing in the set of candidate job listings as relevant or irrelevant with respect to the user, determining that a machine-learned model has been trained for the user, wherein no machine learned model is trained for a user if there is an insufficient number of training examples for the user.
